(19) United States
(12) Patent Application Publication
(10) Pub. No.: US 2026/0073571 A1
(43) Pub. Date: Mar. 12, 2026

(54) CODING FORMAT FOR OPTIMIZED ENCODING OF VOLUMETRIC VIDEO

(71) Applicant: InterDigital CE Patent Holdings, SAS, Paris (FR)

(72) Inventors: Bertrand Chupeau, Rennes (FR); Julien Ricard, Plouër-sur-Rance (FR); Gaëlle Martin-Cocher, Toronto (CA); Edouard Francois, Bourg des Comptes (FR); Franck Galpin, Thorigne-Fouillard (FR)

(21) Appl. No.: 19/126,401

(22) PCT Filed: Oct. 26, 2023
(86) PCT No.: PCT/EP2023/079966

§ 371 Date: May 1, 2025

(30) Foreign Application Priority Data
Nov. 4, 2022 (EP) 22306665.5

(51) Int. Cl. G06T 9/00; H04N 19/17; H04N 19/70

(52) U.S. Cl. CPC G06T 9/001; H04N 19/17; H04N 19/70

(57) ABSTRACT

Methods and devices for encoding and decoding a volumetric scene in a data stream, the volumetric scene being formatted as a list of atlas tiles are disclosed. Embodiments of syntaxes of the metadata describing such a data stream are also disclosed. An indication that the volumetric scene is formatted as a list of atlas tiles is provided, for example by setting the size of a main atlas to zero. The number of atlas tiles in the list and data describing each atlas tiles are also provided. At the decoding, the list of atlas tiles is retrieved by using these metadata.

This application claims the priority to European Application No. 22306665.5, filed Nov. 4, 2022, which is incorporated herein by reference in its entirety.

### 1. TECHNICAL FIELD

The present principles generally relate to the domain of three-dimensional (3D) scene and volumetric video content as a sequence of 3D scenes. The present document is also understood in the context of the encoding, the formatting and the decoding of data representative of the texture and the geometry of a 3D scene for a rendering of volumetric content on end-user devices such as mobile devices or Head-Mounted Displays (HMD). In particular, the present document relates to the encoding of a sequence of lists of atlases prepared to optimize their encoding with a video encoder.

### 2. BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Advances in 3D capturing and rendering technologies makes volumetric video an integral part of Virtual/Augmented/Mixed reality (VR/AR/MR) applications. Volumetric video can be defined as a sequence of 3D frames, that can be in various 3D formats such as point clouds, meshes or multi-view plus depth videos. The need for a high coding efficiency standard for the compression of visual volumetric data has been addressed, for example by the Moving Picture Experts Group (MPEG).

One approach to encode volumetric frames consists in converting the 3D volumetric information into a collection of 2D images and associated data. The converted 2D images can be then coded using 2D video encoders, such as Advanced Video Coding (AVC), High Efficiency Video Coding (HEVC) or Versatile Video Coding (VVC) and the associated data can be coded in an additional metadata stream. The coded images and the associated metadata can then be decoded and used to reconstruct the 3D volumetric information. The Visual Volumetric Video-based (V3C) coding standard developed by MPEG belongs to this 2D-video-compatible approach.

Video-based volumetric encoders transform the input 3D frames into a collection of 2D videos with an image format compatible with legacy 2D-video encoders. However, patch atlases pack together a collection of patches transporting parts of the 3D scene captured from several camera viewpoints. Conventional 2D-video encoding such as HEVC or VVC draw on assumptions about the statistics of input images to achieve high compression performance. The main underlying hypothesis is that the 2D frames to compress are projections (either perspective or equirectangular in case of 360° content) of a 3D scene from a unique viewpoint, yielding thus multiple intra-frame and inter-frame correlations. However, such assumptions are not met by patch atlases output by volumetric encoders, which consist in packing multiples patches with no neighboring correlation in successive frames of a same atlas.

### 3. SUMMARY

The following presents a simplified summary of the present principles to provide a basic understanding of some aspects of the present principles. This summary is not an extensive overview of the present principles. It is not intended to identify key or critical elements of the present principles. The following summary merely presents some aspects of the present principles in a simplified form as a prelude to the more detailed description provided below.

The present principles relate to a method for encoding a volumetric scene. The method comprises obtaining a list of atlas tiles. An atlas tile packs patches that are clustered according to a similarity and continuity criterion. In an embodiment, the list of atlas tiles' video component interleaves attribute atlas tiles' video component with depth atlas tiles' video component. The method comprises generating metadata for the volumetric scene. The metadata comprises an indication whether the volumetric scene is formatted as a list of atlas tiles, a number of atlas tiles in the list of atlas tiles and, for each atlas tile of the list: a size, a location within the atlas tile for each patch packed in the atlas tile. In an embodiment, the indication is provided by setting the size of a main atlas to zero. Then, according to the present principles, the list of atlas tiles and the metadata are encoded in the data stream.

The present principles relate to a device comprising a memory associated with a processor configured for implementing the method above.

The present principles relate to a data stream generated by the device above.

The present principles also relate to a method for decoding a volumetric scene from a data stream. The method comprises decoding metadata from the data stream. The metadata comprises an indication whether the volumetric scene is formatted as a list of atlas tiles, a number of atlas tiles in the list of atlas tiles and, for each atlas tile of the list: a size, a location within the atlas tile for each patch packed in the atlas tile. In an embodiment, the indication is provided by setting the size of a main atlas to zero. Then, according to the present principles, the list of atlas tiles is decoded from the data stream according to the decoded metadata.

The present principles relate to a device comprising a memory associated with a processor configured for implementing the method above.

### 4. BRIEF DESCRIPTION OF DRAWINGS

The present disclosure will be better understood, and other specific features and advantages will emerge upon reading the following description, the description making reference to the annexed drawings wherein:

FIG. 1 is an example of a patch atlas packing in the same video frame a central view of the 3D scene with a collection of smaller patches transporting the dis-occluded parts from other camera viewpoints;

FIG. 2 illustrates the frame packing of two atlas components (a texture atlas and subsampled depth atlas) in a unique video frame;

FIG. 3 shows an example architecture of a device which may be configured to implement a method for encoding or decoding a volumetric scene from a data stream according to the present principles;

FIG. 4 shows an example of an embodiment of the syntax of a stream when the data are transmitted over a packet-based transmission protocol;

FIG. 5 illustrates the patch atlas approach with an example of four projection centers;

FIG. 6 illustrates a different solution for coding video patch atlases in a more efficient way.

### 5. DETAILED DESCRIPTION OF EMBODIMENTS

The present principles will be described more fully hereinafter with reference to the accompanying figures, in which examples of the present principles are shown. The present principles may, however, be embodied in many alternate forms and should not be construed as limited to the examples set forth herein. Accordingly, while the present principles are susceptible to various modifications and alternative forms, specific examples thereof are shown by way of examples in the drawings and will herein be described in detail. It should be understood, however, that there is no intent to limit the present principles to the particular forms disclosed, but on the contrary, the disclosure is to cover all modifications, equivalents, and alternatives falling within the spirit and scope of the present principles as defined by the claims.

The terminology used herein is for the purpose of describing particular examples only and is not intended to be limiting of the present principles. As used herein, the singular forms “a”, “an” and “the” are intended to include the plural forms as well, unless the context clearly indicates otherwise. It will be further understood that the terms “comprises”, “comprising,” “includes” and/or “including” when used in this specification, specify the presence of stated features, integers, steps, operations, elements, and/or components but do not preclude the presence or addition of one or more other features, integers, steps, operations, elements, components, and/or groups thereof. Moreover, when an element is referred to as being “responsive” or “connected” to another element, it can be directly responsive or connected to the other element, or intervening elements may be present. In contrast, when an element is referred to as being “directly responsive” or “directly connected” to other element, there are no intervening elements present. As used herein the term “and/or” includes any and all combinations of one or more of the associated listed items and may be abbreviated as“/”.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the present principles.

Although some of the diagrams include arrows on communication paths to show a primary direction of communication, it is to be understood that communication may occur in the opposite direction to the depicted arrows.

Some examples are described with regard to block diagrams and operational flowcharts in which each block represents a circuit element, module, or portion of code which comprises one or more executable instructions for implementing the specified logical function(s). It should also be noted that in other implementations, the function(s) noted in the blocks may occur out of the order noted. For example, two blocks shown in succession may, in fact, be executed substantially concurrently or the blocks may sometimes be executed in the reverse order, depending on the functionality involved.

Reference herein to “in accordance with an example” or “in an example” means that a particular feature, structure, or characteristic described in connection with the example can be included in at least one implementation of the present principles. The appearances of the phrase in accordance with an example” or “in an example” in various places in the specification are not necessarily all referring to the same example, nor are separate or alternative examples necessarily mutually exclusive of other examples.

Reference numerals appearing in the claims are by way of illustration only and shall have no limiting effect on the scope of the claims. While not explicitly described, the present examples and variants may be employed in any combination or sub-combination.

Video-based volumetric encoders transform the input 3D frames into a collection of 2D videos with an image format compatible with legacy 2D-video encoders. The resulting picture content is of a very specific nature.

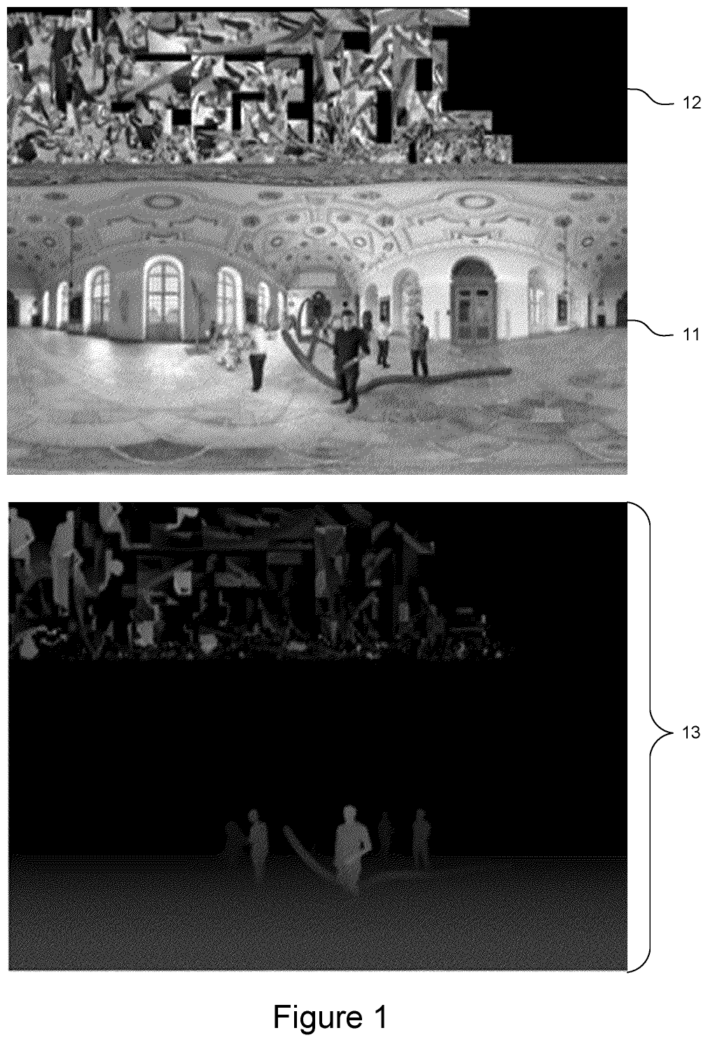

FIG. 1 is an example of a patch atlas packing in the same video frame a central view of the 3D scene 11 with a collection of smaller patches 12 transporting the dis-occluded parts from other camera viewpoints. A corresponding patch atlas 13 with same layout is provided to encode the depth components. This encoding format is, for example, the format adopted in standards like MPEG Immersive Video (MIV).

2D-video encoding such as HEVC or VVC draw on assumptions about the statistics of input images to achieve high compression performance. The main underlying hypothesis is that the 2D frames to compress are projections (either perspective or equirectangular in case of 360° content) of a 3D scene from a unique viewpoint, yielding thus multiple intra-frame and inter-frame correlations. As illustrated in FIG. 1, such assumptions are not met by patch atlases output by volumetric encoders, which consist of the packing of multiples patches with no obvious correlation among neighboring patches.

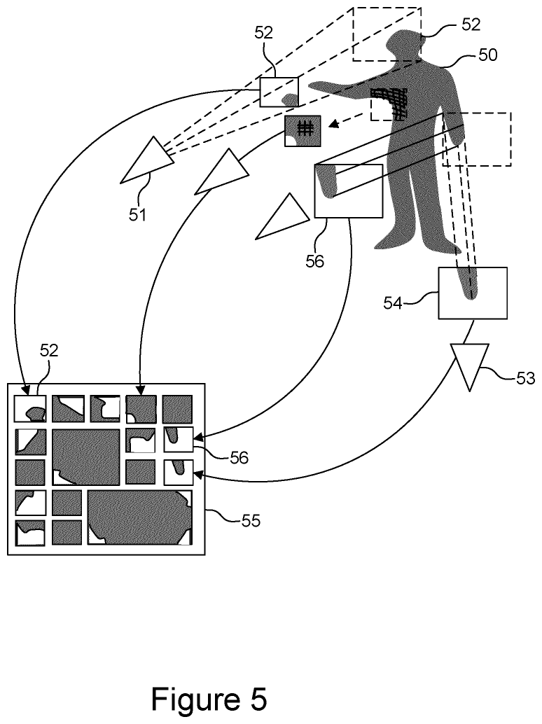

FIG. 5 illustrates the patch atlas approach with an example of four projection centers. 3D scene 50 comprises a character. For instance, center of projection 51 is a perspective camera and camera 53 is an orthographic camera. Cameras may also be omnidirectional cameras with, for instance a spherical mapping (e.g. Equi-Rectangular mapping) or a cube mapping. The 3D points of the 3D scene are projected onto the 2D planes associated with virtual cameras located at the projection centers, according to a projection operation described in projection data of metadata. In the example of FIG. 5, projection of the points captured by camera 51 is mapped onto patch 52 according to a perspective mapping and projection of the points captured by camera 53 is mapped onto patch 54 according to an orthographic mapping.

The clustering of the projected pixels yields a multiplicity of 2D patches, which are packed in a rectangular atlas 55. The organization of patches within the atlas defines the atlas layout. In an embodiment, two atlases with identical layout: one for texture (i.e. color) information and one for depth information. Two patches captured by a same camera or by two distinct cameras may comprise information representative of a same part of the 3D scene, like, for instance patches 54 and 56.

The packing operation produces a patch data for each generated patch. A patch data comprises a reference to a projection data (e.g. an index in a table of projection data or a pointer (i.e. address in memory or in a data stream) to a projection data) and information describing the location and the size of the patch within the atlas (e.g. top left corner coordinates, size and width in pixels). Patch data items are added to metadata to be encapsulated in the data stream in association with the compressed data of the one or two atlases.

Existing formats for encoding atlas-based representation of 3D scene, like MIV format (Text of ISO/IEC FDIS 23090-12 MPEG Immersive Video, ISO/IEC JTC 1/SC 29/WG 4, N00270), does not provide tools or features to leverage the high temporal redundancy of most 3D scenes. The MIV standard, for example, allows to split out the patch-based 3D scene description into multiple atlases (which can themselves be divided into multiple tiles). The patch packing layout and associated projection parameters associated with those atlases are transmitted into a separate “atlas data” sub-bitstream. Full and self-contained (“intra coded”) refreshes of the entire atlas data are only permitted by the MIV profiles, by sending atlas frames at given successive time instants. Whereas the corresponding geometry and attribute (e.g; texture, transparency) samples of the patch atlases are transmitted at the full video frame rate in the video sub-bitsreams. The TMIV reference software (Test Model 14 for MPEG Immersive Video, ISO/IEC JTC 1/SC 29/WG 4, N00242) implements a periodic regular refresh of the atlas data every other 32 video frames, which corresponds to the encoding intra-period of the video bit streams, for optimized video encoding.

The V3C specification ([2] Text of ISO/IEC DIS 23090-5(2E) Visual Volumetric Video-based Coding (V3C) and Video-based Point Cloud Compression 2^{nd} Edition, ISO/IEC JTC 1/SC 29/WG 7, N00297), that MIV is an extension of, offers alternative predictive encoding modes for patch data within the atlas data sub-bitstream, namely ‘inter’, ‘merge’ or ‘skip’, which are not activated by MIV. But such alternative patch encoding modes enable reducing only the bitrate of the atlas data sub-bitstream, which bit-rate is negligible with regard to the other video sub-bitstreams that make the MIV bitstream.

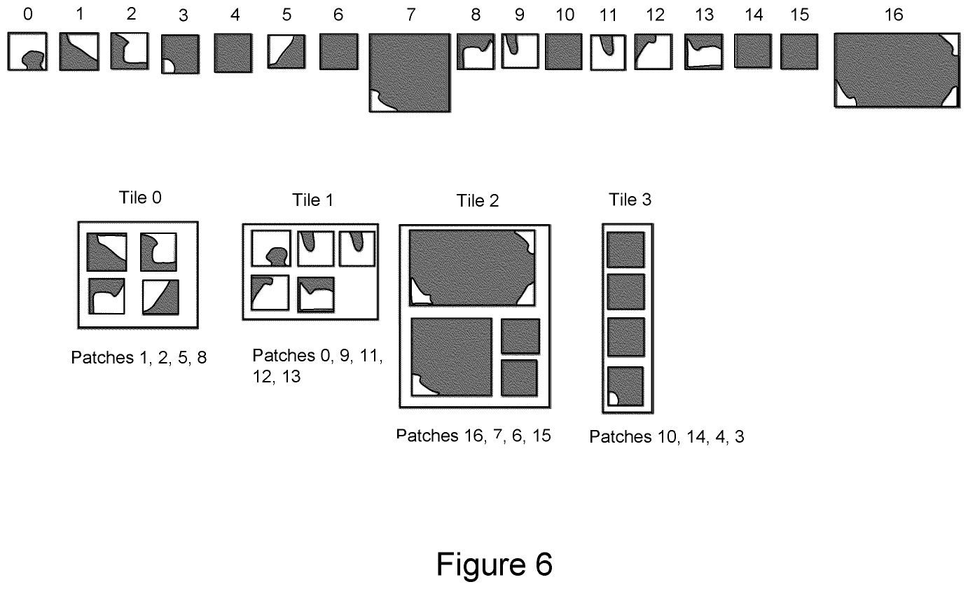

FIG. 6 illustrates a different solution for coding video patch atlases in a more efficient way. In an embodiment of these techniques, the patches are no longer assembled into a rectangular frame, but organized within a collection of rectangular subpictures of varying sizes arranged in a one-dimension (1D) vector layout. Patches presenting strong similarities or continuities are packed into a same subpicture, which size is furthermore dynamically adapted. Inter-subpicture prediction is then allowed. In the example for FIG. 6, a set of seventeen patches is obtained from patch techniques as described in relation to FIG. 5. By comparing similarities and continuities between the patches of the set (and, in an embodiment, between this set of patches and successive sets of patches of the video sequence), patches are distibuted in different atlas tiles. In the example of FIG. 6, patches 1, 2, 5 and 8 are packed in a first atlas tile #0.

In V3C format, each patch has a geometry component containing information about the precise location of 3D data in space (depth map), the occupancy component informing the rendering system of which samples in the 2D components are associated with data in the final 3D representation, together with several attribute components providing additional properties, such as texture (color) or transparency. Additional information about the 3D-to-2D projections is also included in the bitstream to enable inverse reconstruction.

A format for encoding such a representation of a volumetric video has to get rid of the constraint of packing the patches representing the 3D scene at a given time instant into a rectangular atlas frame of fixed dimension. According to the present principles, the patches are distributed and packed into several smaller rectangular frames, of varying sizes, that are referred as “atlas tiles” in this document. Herein, the term “tile” has a different meaning compared to the classical image tiling concept. According to the present principles, an atlas tile is a patch atlas within a list (also called 1D vector) of atlas tiles. An atlas tile is accessed by its index in the 1D vector.

In a first embodiment of the present format, an identical layout (i.e. the patch packing within a tile) is used for the different atlas components (geometry, occupancy and attributes (colour, transparency, etc.)) of a given atlas tile.

The patches are distributed among the different tiles on a similarity and continuity criterion to maximize intra-frame correlation for efficient video compression. As such optimal distribution and packing per tile may be different depending on the atlas component (for example texture and depth patches may not exhibit the same spatial correlations), in a second embodiment, the patch layout of a given tile may be different per atlas component.

According to the present principles, the term “atlas” defines a set of patches associated with a volume of 3D space, not necessarily associated with a placement onto a rectangular frame:

“Atlas: collection of 2D bounding boxes and their associated information corresponding to a volume in 3D space on which volumetric data is rendered.”

Definitions for “2D rectangular atlas” and “1D vector of tiles atlas” are introduced:

“Rectangular atlas: atlas for which 2D bounding boxes are placed onto a rectangular frame.”

“1D-vector of tiles atlas: atlas for which 2D bounding boxes are placed onto several rectangular tiles organized in a 1D layout.”

The following example of syntax for the format proposed by the present principles is inspired by the V3C format in order to be compatible with the V3C format. It is understood that other syntaxes may gather equivalent semantic features. In this example, a “vps_1d_tile_vector_atlas_flag” boolean is present. When equal to 1, the syntax elements signaling the fixed values of atlas frame width a height are not meaningful and, so, are not signaled. The 1D-vector of tiles which replaces the rectangular frame packing when vps_1d_tile_vector_atlas_flag is equal to 1 can be dynamically refreshed at the frame level and is therefore specified in the atlas frame parameter set (AFPS).

| | Descriptor |
|---|---|
| parameter_set( numBytesInPayload ) { | |
| profile_tier_level( ) | |
| vps_parameter_set_id | u(4) |
| vps_1d_tile_vector_atlas_flag | u(1) |
| vps_reserved_zero_ [symbol] 7bits | u( [symbol] 7) |
| vps_atlas_count_minus1 | u(6) |
| for( k = 0; k < vps_atlas_count_minus1 + 1; k++ ) { | |
| vps_atlas_id[ k ] | u(6) |
| j = vps_atlas_id[ k ] | |
| if( vps_1d_tile_vector_atlas_flag == 0 ) { | |
| vps_frame_width[ j ] | ue(v) |
| vps_frame_height[ j ] | ue(v) |
| } | |
| (... ) | |
| } | |

The signaling is repeated at the atlas sequence parameter set (ASPS) level, where the syntax elements defining the atlas frame dimensions (asps_frame_width, asps_frame_height) are no longer meaningful when no rectangular atlas packing.

In an embodiment, an explicit flag asps_1d_tile_vector_atlas_flag is introduced in the ASPS syntax to discriminate between rectangular atlas and 1D vector of tile atlases. However, such a solution is not backward compatible. That means that bitstreams compatible with the current V3C standard would not be decodable by a decoder implemented according to the present principles.

| | Descriptor |
|---|---|
| atlas_sequence_parameter_set_rbsp( ) { | |
| asps_atlas_sequence_parameter_set_id | ue(v) |
| asps_1d_tile_vector_atlas_flag | u(1) |
| if( asps_1d_tile_vector_atlas_flag == 0 ) { | |
| asps_frame_width | ue(v) |
| asps_frame_height | ue(v) |
| } | |
| asps_geometry_3d_bit_depth_minus1 | u(5) |
| asps_geometry_2d_bit_depth_minus1 | u(5) |
| asps_log2_max_atlas_frame_order_cnt_lsb_minus4 | ue(v) |
| asps_max_dec_atlas_frame_buffering_minus1 | ue(v) |
| asps_long_term_ref_atlas_frames_flag | u(1) |
| asps_num_ref_atlas_frame_lists_in_asps | ue(v) |
| for( i = 0; i < asps_num_ref_atlas_frame_lists_in_asps; | |
| i++ ) | |
| ref_list_struct( i ) | |
| asps_use_eight_orientations_flag | u(1) |
| asps_extended_projection_enabled_flag | u(1) |
| if( asps_extended_projection_enabled_flag ) | |
| asps_max_number_projections_minus1 | ue(v) |
| asps_normal_axis_limits_quantization_enabled_flag | u(1) |
| asps_normal_axis_max_delta_value_enabled_flag | u(1) |
| asps_patch_precedence_order_flag | u(1) |
| asps_log2_patch_packing_block_size | u(3) |
| (... ) | |
| } | |

In another embodiment, a backward compatible format is proposed. This consists in using value 0 of asps_frame_width and asps_frame_height to signal a 1d-vector of tiles atlas layout. Indeed, such a zero-sized frame makes no sense for a conventional rectangular atlas. The V3C variable AspsFrameSize associated with the ASPS syntax (set equal to asps_frame_height*asps_frame) can be used for such a purpose:

| condition | atlas type |
|---|---|
| AspsFrameSize > 0 | rectangular atlas |
| AspsFrameSize = 0 | 1d-vector of tiles atlas |

An alternative specification of tiles belonging to a 1D-vector of atlas tiles is provided within the atlas_frame_tile_information( ) syntax structure of the atlas frame parameter (AFPS) of V3C. In that case only the tiles width and height are signaled, as the spatial location within a fixed rectangular atlas frame is no longer meaningful.

| | Descriptor |
|---|---|
| atlas_frame_tile_information( ) { | |
| if( AspsFrameSize > 0 ) { | |
| afti_single_tile_in_atlas_frame_flag | u(1) |
| if( !afti_single_tile_in_atlas_frame_flag ) { | |
| afti_uniform_partition_spacing_flag | u(1) |
| if( afti_uniform_partition_spacing_flag ) { | |
| afti_partition_cols_width_minus1 | ue(v) |
| afti_partition_rows_height_minus1 | ue(v) |
| } else { | |
| afti_num_partition_columns_minus1 | ue(v) |
| afti_num_partition_rows_minus1 | ue(v) |
| for( i = 0; i < afti_num_partition_columns_minus1; i++ ) | |
| afti_partition_column_width_minus1[ i ] | ue(v) |
| for( i = 0; i < afti_num_partition_rows_minus1; i++ ) | |
| afti_partition_row_height_minus1[ i ] | ue(v) |
| } | |
| afti_single_partition_per_tile_flag | u(1) |
| if( !afti_single_partition_per_tile_flag ) { | |
| afti_num_tiles_in_atlas_frame_minus1 | ue(v) |
| for( i = 0; i < afti_num_tiles_in_atlas_frame_minus1 + 1; i++ ) { | |
| afti_top_left_partition_idx[ i ] | u(v) |
| afti_bottom_right_partition_column_offset[ i ] | ue(v) |
| afti_bottom_right_partition_row_offset[ i ] | ue(v) |
| } | |
| } | |
| else | |
| afti_num_tiles_in_atlas_frame_minus1 = NumPartitionsInAtlas | |
| Frame − 1 | |
| } | |
| else | |
| afti_num_tiles_in_atlas_frame_minus1 = 0 | |
| } | |
| else { | |
| afti_num_tiles_in_atlas_frame_minus1 | ue(v) |
| for( i = 0; i < afti_num_tiles_in_atlas_frame_minus1 + 1; i++ ) { | ue(v) |
| afti_tile_width[ i ] | ue(v) |
| afti_tile_height[ i ] | |
| } | |
| } | |
| if( asps_auxiliary_video_enabled_flag ) { | |
| afti_auxiliary_video_tile_row_width_minus1 | ue(v) |
| for( i = 0; i < afti_num_tiles_in_atlas_frame_minus1 + 1; i++ ) | |
| afti_auxiliary_video_tile_row_height[ i ] | ue(v) |
| } | |
| afti_signalled_tile_id_flag | u(1) |
| if( afti_signalled_tile_id_flag ) { | |
| afti_signalled_tile_id_length_minus1 | ue(v) |
| for( i = 0; i < afti_num_tiles_in_atlas_frame_minus1 + 1; i++ ) { | |
| afti_tile_id[ i ] | u(v) |
| TileIDToIndex[ afti_tile_id[ i ] ] = i | |
| TileIndexToID[ i ] = afti_tile_id[ i ] | |
| } | |
| } | |
| else | |
| for( i = 0; i < afti_num_tiles_in_atlas_frame_minus1 + 1; i++ ) { | |
| afti_tile_id[ i ] = i | |
| TileIDToIndex[ i ] = i | |
| TileIndexToID[ i ] = i | |
| } | |
| } | |

Volumetric video standards like V3C provide a “frame packing” functionality that enables combining (packing) in the same video frame several atlas components (geometry, occupancy, attributes) to feed a unique video encoder/decoder with a single video bitstream. A packing_information(atlasID) syntax structure within the VPS specifies which components are packed in this unique video frame. According to such standards, the packing_information(atlasID) syntax structure also specifies the spatial layout of the various packed tile components within the frame. In the case of “1D-vector of tile atlas”, as in the present principles, the packing information bypasses this useless spatial location. The pin_regions_count_minus1 syntax element signals the total number of tile components, that is the total number of video subpictures of various types (depth, occupancy, occupancy, attributes) they are mapped with in the combined bitstream, each tile being accessed by its ID pin_region_tile_id[j][i].

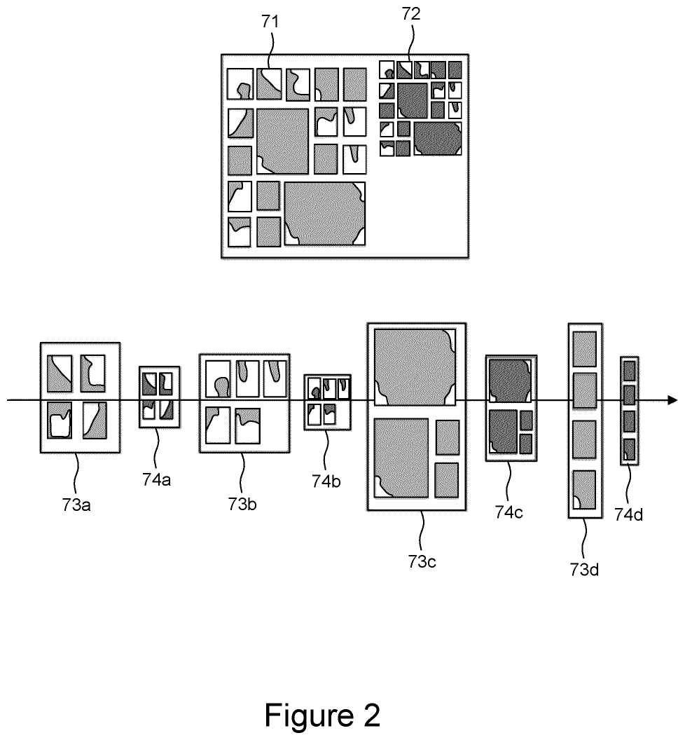

FIG. 2 illustrates the frame packing of two atlas components (texture atlas 71 and subsampled depth atlas 72) in a unique video frame. The two atlas components 71 and 72 are arranged in a rectangular frame. According to the present principles, texture atlas tiles 73a ti 73d are interleaved with depth atlas tiles 74a to 74 d in a unique 1D-vector of subpictures. Interleaving is not restrictive, any other arrangement in the 1D-vector is possible, for example, in a variant, all texture atlas tiles may be listed first followed by all depth atlas tiles.

A possible syntax to embody this organization is provided in the following table:

| | Descriptor |
|---|---|
| packing_information( j ) { | |
| pin_codec_id[ j ] | u(8) |
| pin_occupancy_present_flag[ j ] | u(1) |
| pin_geometry_present_flag[ j ] | u(1) |
| pin_attribute_present_flag[ j ] | u(1) |
| if( pin_occupancy_present_flag[ j ] ) { | |
| pin_occupancy_2d_bit_depth_minus1[ j ] | u(5) |
| pin_occupancy_msb_align_flag[ j ] | u(1) |
| pin_lossy_occupancy_compression_threshold[ j ] | u(8) |
| } | |
| if( pin_geometry_present_flag[ j ] ) { | |
| pin_geometry_2d_bit_depth_minus1[ j ] | u(5) |
| pin_geometry_msb_align_flag[ j ] | u(1) |
| pin_geometry_3d_coordinates_bit_depth_minus1[ j ] | u(5) |
| } | |
| if( pin_attribute_present_flag[ j ] ) { | |
| pin_attribute_count[ j ] | u(7) |
| for( i = 0; i < pin_attribute_count[ j ]; i++ ) { | |
| pin_attribute_type_id[ j ][ i ] | u(4) |
| pin_attribute_2d_bit_depth_minus1[ j ][ i ] | u(5) |
| pin_attribute_msb_align_flag[ j ][ i ] | u(1) |
| pin_attribute_map_absolute_coding_persistence_flag[ j ][ i ] | u(1) |
| d = pin_attribute_dimension_minus1[ j ][ i ] | u(6) |
| if( d == 0 ) { | |
| pin_attribute_dimension_partitions_minus1[ j ][ i ] = 0 | |
| m = 0 | |
| } else | |
| m = pin_attribute_dimension_partitions_minus1[ j ][ i ] | u(6) |
| for( k = 0; k < m; k++ ) { | |
| if( k + d == m ) { | |
| pin_attribute_partition_channels_minus1[ j ][ i ][ k ] = 0 | |
| n = 0 | |
| } else | |
| n = pin_attribute_partition_channels_minus1[ j ][ i ][ k ] | ue(v) |
| d −= n + 1 | |
| } | |
| pin_attribute_partition_channels_minus1[ j ][ i ][ m ] = d | |
| } | |
| } | |
| pin_regions_count_minus1[ j ] | ue(v) |
| for( i = 0; i <= pin_regions_count_minus1[ j ]; i++ ) { | |
| pin_region_tile_id[ j ][ i ] | u(8) |
| pin_region_type_id_minus2[ j ][ i ] | u(2) |
| if( vps_1d_tile_vector_atlas_flag == 0 ) { | |
| pin_region_top_left_x[ j ][ i ] | u(16) |
| pin_region_top_left_y[ j ][ i ] | u(16) |
| pin_region_width_minus1[ j ][ i ] | u(16) |
| pin_region_height_minus1[ j ][ i ] | u(16) |
| pin_region_unpack_top_left_x[ j ][ i ] | u(16) |
| pin_region_unpack_top_left_y[ j ][ i ] | u(16) |
| pin_region_rotation_flag[ j ][ i ] | u(1) |
| } | |
| if( pin_region_type_id_minus2[ j ][ i ] + 2 == V3C_AVD ∥ | |
| pin_region_type_id_minus2[ j ][ i ] + 2 == V3C_GVD ) { | |
| pin_region_map_index[ j ][ i ] | u(4) |
| pin_region_auxiliary_data_flag[ j ][ i ] | u(1) |
| } | |
| if( pin_region_type_id_minus2[ j ][ i ] + 2 == V3C_AVD ) { | |
| pin_region_attr_index[ j ][ i ] | u(7) |
| k = pin_region_attr_index[ j ][ i ] | |
| if( pin_attribute_dimension_minus1[ j ][ k ] > 0 ) | |
| pin_region_attr_partition_index[ j ][ i ] | u(5) |
| } | |
| } | |
| } | |

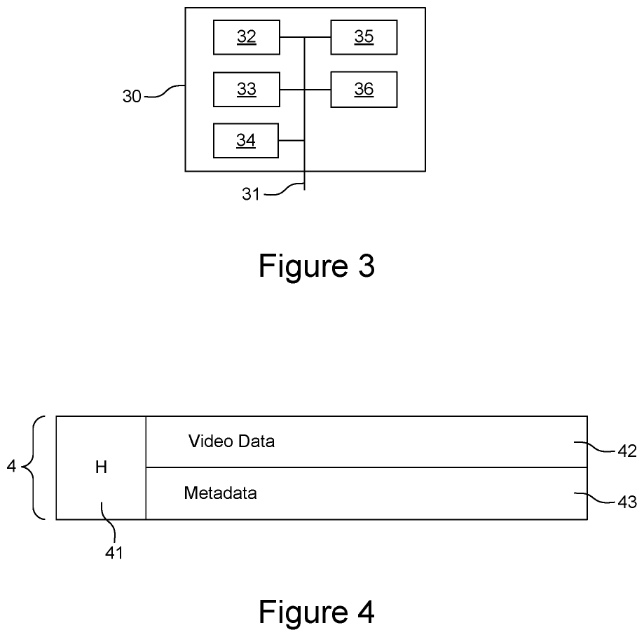

FIG. 3 shows an example architecture of a device 30 which may be configured to implement a method for encoding or decoding a volumetric scene from a data stream according to the present principles. An encoder and/or a decoder may implement this architecture. Alternatively, each circuit of the encoder and/or the decoder may be a device according to the architecture of FIG. 3, linked together, for instance, via their bus 31 and/or via I/O interface 36.

Device 30 comprises following elements that are linked together by a data and address bus 31:
a microprocessor 32 (or CPU), which is, for example, a DSP (or Digital Signal Processor);
a ROM (or Read Only Memory) 33;
a RAM (or Random Access Memory) 34;
a storage interface 35;
an I/O interface 36 for reception of data to transmit, from an application; and
a power supply, e.g. a battery.

In accordance with an example, the power supply is external to the device. In each of mentioned memory, the word «register» used in the specification may correspond to area of small capacity (some bits) or to very large area (e.g. a whole program or large amount of received or decoded data). The ROM 33 comprises at least a program and parameters. The ROM 33 may store algorithms and instructions to perform techniques in accordance with present principles. When switched on, the CPU 32 uploads the program in the RAM and executes the corresponding instructions.

The RAM 34 comprises, in a register, the program executed by the CPU 32 and uploaded after switch-on of the device 30, input data in a register, intermediate data in different states of the method in a register, and other variables used for the execution of the method in a register.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

In accordance with examples, the device 30 belongs to a set comprising:
a mobile device;
a communication device;
a game device;
a tablet (or tablet computer);
a laptop;
a still picture camera;
a video camera;
an encoding chip;
a server (e.g. a broadcast server, a video-on-demand server or a web server).

FIG. 4 shows an example of an embodiment of the syntax of a stream when the data are transmitted over a packet-based transmission protocol. FIG. 4 shows an example structure 4 of a volumetric video stream. The structure consists in a container which organizes the stream in independent elements of syntax. The structure may comprise a header part 41 which is a set of data common to every syntax elements of the stream. For example, the header part comprises some of metadata about syntax elements, describing the nature and the role of each of them. The header part may also comprise a part of metadata described in tables of the present document. The structure comprises a payload comprising an element of syntax 42 and at least one element of syntax 43. Syntax element 42 comprises data representative of the color and depth frames formatted as a list of atlas tiles. Images may have been compressed according to a video compression method.

Element of syntax 43 is a part of the payload of the data stream and may comprise metadata about how frames of element of syntax 42 are encoded, for instance an indication whether the volumetric scene is formatted as a list of atlas tiles, a number of atlas tiles in said list of atlas tiles and for each atlas tile of said list a size and a location within the atlas tile for each patch packed in the atlas tile.

According to the present principles, a transmission format is provided to efficiently support a compact and flexible description of 3D scenes with large parts having constant, or only slowly evolving, geometry and appearance. In addition, for entities that are static in the physical world of the 3D scene, encoding and decoding techniques are proposed when the camera rig is moving and/or when the lighting conditions evolve over time.

When the camera moves, static 3D scene parts are seen as moving parts in the frame of reference of the camera rig. According to the present principles, at encoder side the camera rig motion is estimated (pose parameters=position and orientation) and transmitted to the decoder. Doing so, the patches of the static scene parts transmitted are used at later times at decoder side, with a compensation of the camera movement.

The lighting condition change case is very frequent in sequence of 3D scenes (even full CGI 3D scenes). In this case, the geometry does not change but the appearance does because of varying lighting or shadows. According to the present principles, the texture (i.e. color attribute) of static patches are updated more frequently than the geometry attribute. In another embodiment, a compact expression of texture changes under the form of a parametric mathematical function is encoded in the data stream and transmitted to the decoder.

The main elements of the proposed solution are the following:
At encoder stage, the static or quasi-static 3D scene parts are identified, and their patch-based description is separated from the description of the rest of the scene;
The static patches are clustered into a set of long-term persistence entities;
The static patch description is refreshed at entity granularity, only when needed by the 3D scene evolution;
The decoder maintains a data structure in memory (e.g. a database) of decoded patches in memory to render the static parts of the scene, by updating the entities (erase, rewrite, add) when required.

The implementations described herein may be implemented in, for example, a method or a process, an apparatus, a computer program product, a data stream, or a signal. Even if only discussed in the context of a single form of implementation (for example, discussed only as a method or a device), the implementation of features discussed may also be implemented in other forms (for example a program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, Smartphones, tablets, computers, mobile phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding, data decoding, view generation, texture processing, and other processing of images and related texture information and/or depth information. Examples of such equipment include an encoder, a decoder, a post-processor processing output from a decoder, a pre-processor providing input to an encoder, a video coder, a video decoder, a video codec, a web server, a set-top box, a laptop, a personal computer, a cell phone, a PDA, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette (“CD”), an optical disc (such as, for example, a DVD, often referred to as a digital versatile disc or a digital video disc), a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium (such as a storage device) having instructions for carrying out a process. Further, a processor-readable medium may store, in addition to or in lieu of instructions, data values produced by an implementation.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application.

1. A method of encoding a volumetric scene, the method comprising:
obtaining a list of atlas tiles, an atlas tile packing patches clustered according to a criterion based on similarity and continuity;
generating metadata comprising:
an indication on whether the volumetric scene is formatted as a list of atlas tiles;
information indicating a number of atlas tiles in the list of atlas tiles; and
for each atlas tile of the list:
a size; and
a location within the atlas tile for each patch packed in the atlas tile; and
encoding the list of atlas tiles and generated metadata in a data stream.

2. The method of claim 1, wherein the indication on whether the volumetric scene is formatted as a list of atlas tiles is a size of a main atlas set to zero.

3. The method of claim 1, wherein the list of atlas tiles' video component interleaves attribute atlas tiles' video component and depth atlas tiles' video component.

4. A device for encoding a volumetric scene and comprising a memory associated with a processor configured for:
obtaining a list of atlas tiles, an atlas tile packing patches clustered according to a criterion based on similarity and continuity;
generating metadata comprising:
an indication on whether the volumetric scene is formatted as a list of atlas tiles;
information indicating a number of atlas tiles in the list of atlas tiles; and
for each atlas tile of the list:
a size; and
a location within the atlas tile for each patch packed in the atlas tile; and
encoding the list of atlas tiles and generated metadata in a data stream.

5. The device of claim 4, wherein the indication on whether the volumetric scene is formatted as a list of atlas tiles is a size of a main atlas set to zero.

6. The device of claim 4, wherein the list of atlas tiles' video component interleaves attribute atlas tiles' video component and depth atlas tiles' video component.

7. A method for decoding a volumetric scene from a data stream; the method comprising:
decoding metadata from the data stream, the metadata comprising:
an indication whether the volumetric scene is formatted as a list of atlas tiles;
information indicating a number of atlas tiles in the list of atlas tiles; and
for each atlas tile of the list:
a size; and
a location within the atlas tile for each patch packed in the atlas tile; and
decoding the list of atlas tiles from the data stream according to the metadata.

8. The method of claim 7, wherein the indication on whether the volumetric scene is formatted as a list of atlas tiles is a size of a main atlas set to zero.

9. The method of claim 7, wherein the list of atlas tiles' video component interleaves attribute atlas tiles' video component and depth atlas tiles' video component.

10. A device for decoding a volumetric scene from a data stream and comprising a memory associated with a processor configured for:
decoding metadata from the data stream, the metadata comprising:
an indication whether the volumetric scene is formatted as a list of atlas tiles;
information indicating a number of atlas tiles in the list of atlas tiles; and
for each atlas tile of the list:
a size; and
a location within the atlas tile for each patch packed in the atlas tile; and
decoding the list of atlas tiles from the data stream according to the metadata.

11. The device of claim 10, wherein the indication on whether the volumetric scene is formatted as a list of atlas tiles is a size of a main atlas set to zero.

12. The device of claim 10, wherein the list of atlas tiles' video component interleaves attribute atlas tiles' video component and depth atlas tiles' video component.

13. A non-transitory readable medium carrying data representative of a volumetric scene and comprising:
metadata comprising:
an indication whether the volumetric scene is formatted as a list of atlas tiles;
a number of atlas tiles in the list of atlas tiles; and
for each atlas tile of the list:
a size;
a location within the atlas tile for each patch packed in the atlas tile; and
the list of atlas tiles.

14. The non-transitory readable medium of claim 13, wherein the indication whether the volumetric scene is formatted as a list of atlas tiles is a size of a main atlas set to zero.

15. The non-transitory readable medium of claim 13, wherein the list of atlas tiles' video component interleaves attribute atlas tiles' video component and depth atlas tiles' video component.
